(19) United States
(12) Patent Application Publication
(10) Pub. No.: US 2007/0284289 A1
(43) Pub. Date: Dec. 13, 2007

(54) Process to prepare mixed molded carbide and nitrite material and its application as a catalyst in hydrotreatment processes

(75) Inventors: Jose Augusto Jorge Rodrigues, Lorena (BR); Victor Luis Dos Santos Teixeira Da Silva, Rio de Janeiro (BR); Marisa Aparecida Zacharias, Lorena (BR); Carlos Alexandre Miglioli, Resende (BR); Jose Luiz Zotin, Rio de Janeiro (BR)

Correspondence Address: NIXON & VANDERHYE, PC, 901 NORTH GLEBE ROAD, 11TH FLOOR, ARLINGTON, VA, 22203, US

(73) Assignee: PETROLEO BRASILEIRO S.A.-PETROBRAS, Rio de Janeiro (BR)

(21) Appl. No.: 11/785,417

(22) Filed: Apr. 17, 2007

(30) Foreign Application Priority Data
Apr. 17, 2006 (BR) PI 0601404-6

(51) Int. Cl. B01J 27/22; C10G 47/24; C10G 35/00

(52) U.S. Cl. 208/209; 208/108; 423/1; 423/53; 502/177

(57) ABSTRACT

A process to prepare new catalysts made from mixed metal oxides of transition metals, which involves the preparation of precursors and synthesis of these materials in oxide form from the preparation of a sol-gel formed from inorganic salts of these metals. An advance in the preparation of these catalysts made of mixed transition metal carbides and nitrides is proposed, providing an alternative way to the process of synthesis by solid-state reaction. The final product, in extruded form, has textural and mechanical properties superior to those obtained by the known techniques in the state of the art, and with better catalytic activity for hydrotreatment reactions.

### CROSS REFERENCE TO RELATED APPLICATION

This application is based upon, claims the benefit of, priority of, and incorporates by reference, the contents of Brazilian Patent Application No. PI 0601404-6 filed Apr. 17, 2006.

### FIELD OF THE INVENTION

This invention deals with a process to prepare multi-metal materials based on transition metals, using co-precipitation of compound mixtures coming from solutions containing the metals. The technique of co-precipitation under the conditions conducted in this invention allows material to be molded by extrusion, resulting in “pellets” with superior physicochemical properties. They may be used as an adsorbent, catalyst precursor material, catalyst or catalyst support, or even as inert filler in the reactor or column. In particular, the materials are used as precursors to catalysts in hydrotreatment process for oil streams, most specifically for the hydrotreatment of gas-oil.

### BACKGROUND OF THE INVENTION

The new fuel specifications, regarding the reduction of sulfur, aromatics content and olefins, have lead to a search for more active and selective catalysts for the hydrotreatment process for fuels. These catalysts aimed at operating conditions more soft in existing units, minimizing operational costs and increasing the working life of these units, or at projects that use lower pressure and lower volumes of reactors, reducing the investment in new facilities.

Among the various lines of development for catalysts, the use of carbides or metal nitrides has shown promise, mainly for processing of streams containing low sulfur levels.

Metal carbides and metal nitrides may be defined as metal compounds containing carbon or nitrogen in the interstices of the metal grid. In addition to possessing metallurgical properties, such as hardness and exceptional mechanical strength, these materials also have interesting catalytic properties. Such properties were revealed mainly during the 1960's by researchers in the Boudart et al group (R. B. Levy, M. Boudart, Science 181, 1973, 547), who showed that materials like molybdenum carbide and tungsten carbide possess catalytic properties that vary quite a bit from corresponding metals and are similar to those presented by the noble metals, such as platinum, palladium and rhodium, which are all elements much more expensive.

The application of these materials in hydrotreatment reactions has been revealed by several researchers, in open literature as well as in patent literature, such as, for example, the US Patents: U.S. Pat. Nos. 4,271,041 (Boudart et al), 4,325,842 and 4,325,843 (Slaugh et al), 5,451,557 and 5,573,991 (Sherif). These works show the potential of these carbide and nitride catalysts in the hydrotreatment of oil streams, such as gasoline, kerosene, and diesel, showing, in many cases, higher activity than the conventional catalysts of metal sulfides, notably, mixed sulfides of nickel and molybdenum or cobalt and molybdenum for hydro treating.

Most papers have shown good results by using carbides or nitrides of a single transition metal, normally molybdenum or tungsten, having reports on mixed carbides containing cobalt or nickel in association with molybdenum or tungsten, as an example of the formulation of catalysts of metal sulfide.

The disadvantage of the use of carbides and nitrides is the relatively severe synthesis conditions—it is normally employed temperatures above 600° C. or 700° C., besides, these materials possess a pyrophoric nature when exposed to air.

This severe synthesis conditions can be bypassed, according to U.S. Pat. No. 4,515,763, using a stage called “passivation”, during which the catalyst material is exposed to low levels of oxygen, followed by an “in situ” process of reactivation by hydrogen treatment. This reactivation treatment, however, does not recover the total initial activity, as was demonstrated in several works.

Another difficulty in employing these materials consists of its format/formation/molding. For industrial use, catalysts should be supplied in defined sizes and shapes, in order to provide the proper size for reactors regarding the flow of reagent streams, and with physical properties, such as mechanical resistance to compression and friction, and textures, as well as volume and pore diameters, which should be suitable for good performance as a catalyst. These properties are strongly influenced by the formatting method. U.S. Pat. No. 5,200,060 (Sajkowski et al) states that catalysts that are in spherical or extruded form, with a diameter in the range of between 0.02 cm to 0.2 cm, give good results in terms of contact with the hydrocarbon load, in fixed bed reactors as well as in processes that use expanded beds.

Regarding the format of catalysts, U.S. Pat. No. 4,977,123 (Flytzani-Stephanopoulos et al) describes an extrusion method of mixed metal oxides which results in catalysts that combine a high specific area and good mechanical strength. Related work in the literature does not specify a formatting process for carbides and nitrides in application in HDT reactions.

Recently, Rodrigues et al developed a method for the preparation of molybdenum and tungsten carbides and nitrides, all extruded, to be used in the aerospace sector, as an hydrazine decomposition catalyst. This method involves the preparation of a molybdenum or tungsten precursor compound, which is extruded in suitable conditions, followed by heat treatment and, finally, carburization, in the presence of a mixture of hydrogen and methane, or nitridization in the presence of ammonia. The catalyst, obtained in this way, has a suitable mechanical strength for space use. (Catalysis Letters, Vol. 45, 1-3, 1997).

Recently, Oyama et al (C. C. Yu, S. Ramanathan, B. Dhandapani, J. G, Chen, S. T. Oyama, J. Phys. Chem., 8101, 1997, 512) also describe the use of bimetal carbides for hydrotreatment reactions, in particular, the mixed carbide of molybdenum and niobium, which is considered superior to single carbides and to conventional hydrotreatment catalysts. The authors used the synthesis method called “solid-state reaction” that consists of heating the oxides of the two metals at high temperature, in order to obtain a mixed oxide of molybdenum and niobium, followed by a carburization stage. Due to the high temperatures used during synthesis of mixed oxides, always above 700° C., the material sinters, a phenomenon that hinders in obtaining the proper rheological properties in its formation/structure; particularly for obtaining pellets by extrusion, method that is used in the preparation of hydrotreatment catalysts, when production in industrial scale is expected. The difficulty of peptization (physicochemical process responsible for the union of the metal precursor particles in the extrusion process) becomes necessary to add binding agents at high concentration, which may cause contamination and/or reduction of the level of active material present in the catalyst.

An alternative for obtaining molded mixed oxides, for example, by extrusion, consists of the method described by Pechini in U.S. Pat. No. 3,330,697—“Method of preparing lead and alkaline earth titanates and niobates and coating method using the same to form a capacitor”. This method involves the organic chelate formation of precursor metals, followed by polymerization and thermal decomposition. By properly controlling the water content in the product, extruded compounds of these materials may be obtained for later nitridization or carburization. In spite of producing a material with good properties, one disadvantage to this method is the fact that it uses organic agents, such as citric acid or ethylene glycol, which makes the production process more expensive, eventually generating waste, principally carbon, in the extruded material.

### SUMMARY OF THE INVENTION

This invention proposes an advance in the preparation of multi-metal catalysts made of mixed transition metal carbides and nitrides, providing an alternative to the “solid-state reaction” method of synthesis for precursors.

The final product, in extruded form, has textural and mechanical properties superior to those obtained by the known techniques in the state of the art, such as, better catalytic activity for hydrotreatment reactions.

This invention also proposes a methodology to preserve original activity of the catalyst after the carburization or nitridization stage, with this, avoiding the passivation stage with oxygen, said stage, in accordance with mentioned above, definitely compromises the catalytic activity of the material.

The process proposed by this invention has advantages which mainly consist of using moderate temperatures and releasing the use of organometallic reagents and solvents in large quantities.

Another advantage is the addition of facilitating agents for structure, such as organic agents and inert material. The technique employed by the process now proposed makes the addition of these materials unnecessary.

This and other advantages will become evident for specialists in the subject as the process of the invention is described below.

This invention deals with a process to prepare catalysts from metals, in which at least one of these is a transition metal, and involves synthesis of materials in the form of mixed oxides, from a mixture of inorganic salts of metals and the formation of a sol-gel, to obtain the catalyst in its final form of a molded mixed carbide or nitride.

The process provides a material suitable for obtaining extruded material with superior physicochemical properties. The material obtained has superior catalytic properties and lends itself to converting sulphurized and nitrogenized, and aromatic compounds in the oil stream in the presence of hydrogen.

### DETAILED DESCRIPTION OF THE INVENTION

This invention is based on the fact that the process of preparation now presented, through co-precipitation of the precursor of mixed oxides, allows obtaining a paste with binding properties, which are appropriate for obtaining carbide in an extruded form.

In a more detailed manner, the process of this invention leads to obtaining catalysts of mixed metal carbide and nitride which contain at least one transition metal. The new catalysts are obtained from precursors formed by mixing inorganic salts of these metals, under controlled and selected reaction conditions in accordance with the salt of the metal chosen, mainly temperature, pH, and addition time, in order to constitute a mixture of oxides, in which these oxides are homogeneously distributed and dispersed. A moist paste is obtained that may be properly formatted, and then dried and calcined, under programmed temperature conditions.

Later, based on whether mixed carbide or mixed nitride is desired, the material will be exposed to a treatment stream that leads to forming the desired product.

In general terms, the process for preparing the catalyst proposed by this invention includes the following stages:
a) mix, under stirring, at least two solutions prepared by the dissolution of soluble compounds of metals, in which at least one is a transition metal, under controlled conditions of temperature, pH, metal concentration, and addition time, set in function of involved metals, until a formation of a precipitate occurs, and in some cases the aged of a precipitate;
b) adjust, in some cases, the pH of the reaction medium by the action of an acid or basic inorganic agent, added to the reaction medium in order to accelerate the co-precipitation stage;
c) filter and/or centrifuge the precipitate in order to obtain a moist paste that provides conditions for molding;
d) peptize and re-disperse the solid in an acid or basic agent in order to obtain a suspension with binding properties;
e) eliminate the excess of moisture from the solid obtained and formatting it in accordance with the chosen technique, preferably by extrusion;
f) dry and calcine the formatting solid, according to a programmed selected temperature, established in function of the metals present in the precursor, in order to obtain a mixed metal oxide ready to be carburized, nitriding or sulfiding;
g) expose the mixed metal oxide to a treatment stream that directs it to form a mould mixed carbide, a mould mixed nitride, or a molded mixed sulfide; and
h) store mould carbides and nitrides in an organic compound that is liquid or solid at room temperature.

In order to obtain the compounds, first the precursor solutions containing the metals of the desired mixed oxide are prepared. In a preferred implementation, inorganic salts precursors of the mixed oxide desired are used. These solutions are mixed gently by stirring, under controlled conditions of temperature, pH, and time of adding the solution, and promoting the forming of a precipitate, where the final product of this stage is a precursor suspension of the desired oxide. In a preferred implementation, the suspension takes the form of an inorganic gel.

The suspension thus obtained is kept under stirring, for a period of some minutes up to 24 hours, preferably from a few minutes to 2 hours, in a period of maturation during which the precipitation reactions will take place. In a preferred implementation, the temperature and the pH of the suspension are controlled. In the preferred implementation, the temperature and the pH of the suspension are the same as the precipitation stage.

Metal oxide precursors are useful in this invention, such as nitrate, chloride, carbonate, phosphate, sulfate, and oxalate salts of the selected metals, but not limited to these examples. Metal oxide precursors where the metal is in the form of an anionic complex are equally useful, such as molybdates, niobates, chromates, but not limited to these examples.

In the preferred implementation, after mixing the solutions, the pH of the reaction medium needs to be adjusted by the addition of an acid or basic agent, in order to favor the co-precipitation of the multi-metal precursors. In this case, inorganic acids or bases are useful, but not limited to these examples.

The solids may be separated from the suspension obtained in the former stage by decantation, filtration, under vacuum or with the help of a press type of filter, or centrifugation, but not limited to these examples.

The solid thus obtained contains the precursor of the mixed oxide desired in the form of a paste, which is dried in the presence of air, at a temperature between 40° C. and 300° C., preferably between 40° C. and 150° C. Preferably, the dry material should possess an amorphous crystalline structure under X-Ray Diffraction, indicating a good dispersion and interaction of the metals in the compound obtained.

The compound thus prepared, but not molded, may be calcined in the open air, at temperatures between 100° C. and 1000° C., preferably between 200° C. and 600° C., in such a way to decompose the precursors and to supply the mixed oxides desired.

This material may also be processed in several ways to obtain formatted solids which are more suitable for use in fixed bed reactors or filler columns (packed columns). One possibility consists of re-disperse the dry material by adding water and a solution containing a peptizing agent, in such a way to form a paste with binding rheological properties and that provides proper conditions for formatting. Formatting should be understood as the processes of extrusion, chipping, spray-drying, oil drop, spherodization, but not limited to these examples. Peptizing agent should be understood as chemical compounds capable of conferring plastic properties to the pastes thus obtained, such as monoprotic acids and bases and their respective salts, but not limited to these examples.

Another possibility consists of adjusting the level of moisture in the moist paste obtained by filtration, without going through the drying stage, and to add to that paste a solution of a peptizing agent, to make a paste with binding properties, and that supplies proper conditions for formatting.

The formatted material must be dried at temperatures between 40° C. and 300° C., preferably between 40° C. and 150° C., followed by calcination in the open air, at temperatures between 100° C. and 1000° C., preferably between 200° C. and 600° C., in such a way to decompose the precursors and to provide forming the mixed oxides desired. The material then obtained is ready to be used as a catalyst, catalyst support, catalyst precursor, adsorbent or inert filler for the reactor or column.

To prepare the metal carbide or metal nitride of the solid material obtained in accordance to the procedure previously described, it may be carburized, to form the respective metal carbide, or nitriding, to obtain the respective metal nitride.

In the carburization stage, the solid is submitted to a reaction with a carbon precursor in a reducing atmosphere. Hydrocarbons may be used as a source of carbon, such as the alkanes, preferably methane, cycloalkanes, oil streams, but not limited to this example. As a reducing agent, hydrogen, carbon monoxide or a mixture of both may be used.

The solid is heated at a controlled heating rate, in the presence of the carburization mixture, up to the suitable temperature which is a function of the metals present in the precursor of the desired mixed oxides, maintaining this temperature for at least 1 hour. For example, the final carburization temperature for molybdenum-niobium oxides is found within the range between 400° C. and 900° C., preferably between 500° C. and 800° C. The solid thus obtained presents the typical properties of metal carbides.

Nitriding is conducted in a similar manner, using ammonia as a source of nitrogen, instead of using a hydrocarbon compound.

In order to preserve the catalytic properties of solid compounds obtained (mixed carbides or nitrides) and avoid passivation process with oxygen, the newly synthesized compounds are collected in a liquid organic compound that has been pre-treated to remove any gaseous fraction that might be present, at the same temperature of the process, proceeding the storage of the catalyst under an inert atmosphere. Thus, the contact of carbides and nitrides with the oxygen in the air is avoided, facilitating their handling and transportation.

Organic compounds from paraffin, isoparaffins, cyclo-paraffins, aromatics, polyaromatics classes, or combinations of these functions are useful in this operation. Heterorganic compounds, principally those containing sulfur and oxygen, should, in principle, be avoided so as to not contaminate the catalyst. Paraffin compounds are particularly preferred, containing between 6 and 60 atoms of carbon, liquids or solids at room temperature.

The catalysts thus obtained can be used as catalysts in hydro processing reactions, such as the removal of organic sulphurized compounds (hydrodesulphurization—HDS), removal of organic nitrogenized compounds (hydrodenitrogenization—HNS), removal of unsaturated and aromatic compounds (hydrogenation—HD), and the conversion of heavy compounds in lighter fractions (hydro cracking—HCC). Such reactions are applied in hydrocarbon streams within the range of naphtha, kerosene, gas-oils, heavy and waste gas-oils.

In a typical practice, the hydrocarbon stream reacts with hydrogen in the presence of the catalyst, in proper conditions of temperature, pressure, hydrogen/hydrocarbon stream ratio, and spatial time. Typical total pressure values of the process are found between 20 and 150 kgf/cm²; typical temperature values are between 200 and 450° C.

The use of the catalyst is done by loading it together with the protective solvent in the rectional vessel, and heating them in the presence of a hydrogen flow or an inert gas. Under these operational conditions, the protective solvent is expelled from the catalyst, releasing it for using in the reactions of interested.

The use of the technique to prepare mixed oxides through sol-gel route using inorganic salts as precursors, according to the process of the invention, represents an alternative route, less expensive than sol-gel route with organic metal precursors of the previous technique, and provides a material with better textural and catalytic properties.

Compared with the synthesis method by reaction in solid state, this invention provides a final catalyst with larger specific area and, consequently, having larger activity, besides allowing the formatting in extruded material for industrial use.

The examples presented below are for the purpose of illustrating the invention and facilitating understanding, and in no way restrict these.

### EXAMPLE 1

In this example, the process for preparing mixed molybdenum and niobium oxides is described as presented in the method proposed by this invention, during which it is verified the quick and intense transition from “sol” to “gel” (sol-gel) of the reaction medium.

To an aqueous solution of molybdenum, obtained by dissolving 12.8 g of ammonium molybdate in 75 mL of water, keep under stirring and cooled at temperature below 5° C., it is added a pre-filtered niobium aqueous solution, obtained by dissolving 10.0 g of ammonium niobium oxalate in 160 mL of water, keep under stirring at a temperature of around 5° C. The pH of the niobium solution is between 0.8 and 1.3 and the pH of the molybdenum solution is between 4.9 and 5.3. After mixing, the solution is maintained below 5° C., with the help of an ice bath and coarse salt, while it is vigorously stirring (780-800 rpm). After about 10 minutes, it will be observed that the solution has become gradually cloudy and highly viscous while, as at the same time, it is formed a white gel with a pH of between 2.8 and 3.3. The formed gel is kept in repose at room temperature and pressure for 24 hours. Then, it is isolated from the solution by vacuum filtration. This gel filtration is extremely slow (between 10 and 15 hours), and the isolated product is the precursor material of the mixed oxide.

The resulting product is dried on an oven at a temperature of approximately 60° C. for 24 hours. After this period, the vitreous, green material is crushed and sifted (0.105 mm) and after, submitted to molding stages and thermal treatment.

The extrusion of this material may be performed in accordance to the following procedure: a known quantity of the sifted precursor is transferred to a porcelain mortar, and, then, drop by drop a dispersal agent (H₂O, HNO₃, NH₄OH and acetic acid) is added. The addition of this agent continues until a homogeneous and consistent paste is obtained, which has the proper rheological properties for extrusion. This maceration/dispersion operation takes about one hour. Finally, the paste is transferred to a pressing device to be molded by extrusion.

The bimetallic extruded products should remain exposed to the air for 24 hours. After, it is transferred to stoves maintained at 60° C. and, later, at 120° C., in which they should be kept for 24 hours at each temperature. Finally, the bimetallic extruded compounds are calcined at 600° C. and 700° C. respectively, remaining 4 to 5 hours at specific temperature for each case. The rate of heating used is approximately 2° C. per minute. The material obtained according to this methodology presents a mechanical resistance of 8.2 N/mm. This solid shall be referred to as MoNb-SG.

### EXAMPLE 2

In this example, the preparation of mixed molybdenum and niobium oxides by the method proposed in this patent application is described. However, the thermal treatment stage was optimized in order to generate materials with larger mechanical strength.

The procedure to obtain extruded products was performed as described in Example 1. After the bimetallic extruded products were obtained, these remain exposed to the air during 24 hours. After, they are transferred to a microprocessor oven at a high temperature as programmed from room temperature up to 130° C. (approximately 0.40° C./minute), remaining for 60 minutes at 130° C., raising the temperature from 130° C. up to 700° C. at a rate of 0.75° C./min. and remaining for 5 hours at 700° C. An oxygen flow of 1200 mL/minute is introduced, starting at the beginning of treatment.

The extruded material, after this treatment, presents a mechanical resistance of 32.5 N/mm. This solid shall be referred to as MoNb-SG

### EXAMPLE 3

In this example, the preparation of mixed molybdenum and niobium oxides by the method proposed in this patent application is described. However, the thermal treatment stage was adjusted in order to maximize the results of mechanical strength obtained in Example 2. The procedure to obtain extruded material was performed as described in Example 1.

After obtaining the bi-metal extruded products, they remain exposed to the air for 24 hours. After, they are transferred to a microprocessor oven and the temperature is raised in a programmed way, from room temperature up to 130° C. at a rate of approximately 0.40° C./minute, remaining for 30 minutes, raising the temperature from 130° C. up to 400° C. at a rate of 0.30° C./minute and remaining at this temperature for 3.5 hours. An oxygen flow is introduced (1200 mL/minute) when the temperature reaches 400° C. The temperature is raised from 400° C. up to 700° C. at a rate of 0.75° C./minute, remaining at this temperature for five hours. The extruded material, after this procedure, presents a mechanical resistance of 39.5 N/mm. This solid shall be referred to as MoNb-SG.

### EXAMPLE 4

This example shows how it is possible to control the porosity properties of the final material by adding porogenous agents, such as microcrystalline cellulose, amides, etc. This addition does not reduce the mechanical strength to values that would make the product improper for industrial application. The procedure for obtaining the precursor of the extruded material is performed as described in Example 1, except for the extrusion molding stage, during which approximately 5-10% of amide is added to the amorphous bi-metal precursor.

After obtaining the bi-metal extruded products, they should remain exposed to the air for 24 hours. After, they are transferred to a microprocessor oven and the temperature is raised, in a programmed way, from room temperature up to 130° C. at a rate of approximately 0.40° C./minute, remaining for 30 minutes, raising the temperature from 130° C. up to 400° C. at a rate of 0.30° C./minute and remaining at this temperature for 3.5 hours. An oxygen flow is introduced (1200 mL/minute) when the temperature reaches 400° C. In the next stage, the temperature is raised from 400° C. up to 700° C. at a rate of 0.75° C./minute, remaining for five hours at this temperature. The extruded material, after this procedure, presents a mechanical resistance of 14.4 N/mm.

This solid shall be referred to as MoNb-SG.

### EXAMPLE 5

In this example, the preparation of a mixed oxide using the method known as “solid-state reaction” as applied to the preparation of mixed carbide and nitride catalysts, is described in accordance with the state of the art.

In accordance with the procedure used in the state of art, 5.48 g of molybdenum trioxide and 3.38 g of niobium pentoxide, both in powder form, are mixed and placed in a mortar. With a pestle to use as a mechanical means of homogenization and crushing, it is added drop by drop of ethanol as a chemical re-dispersion agent to the powders, until obtaining a paste that is possible to be mold. This paste is transferred to an appropriate device and is pressed on a wafer form. It should be noted that it is not possible to carry out peptization of the mixture of precursor oxides, and consequently, it is also impossible to carry out the stage of mold by extrusion.

After being exposed to air for 24 hours, the wafers are dried by heating them to 60° C. and 120° C., respectively. They should also remain during 24 hours at each stage. Calcination is performed by submitting the wafers to a heating ramp of approximately 5° C./min. until the temperature of 785° C. is reached. It should be kept at this baseline for 6 hours. This solid shall be referred to as MoNb-SS.

### EXAMPLE 6

In this example, the preparation of a mixed oxide by the method called “Pechini”, as applied to the preparation of multi-metal oxides, is described in accordance with the state of art. According to this procedure, chelates of the precursors of metal oxide must be obtained first.

Initially, a citric acid solution is prepared by adding 200 mL of water, under stirring and soft heating (50° C.), to 201.2 g of citric acid. After dissolution, the solution is kept under stirring to later adding the salts of the mentioned metals. A solution of molybdenum citrate is prepared by adding 25.6 g of molybdic acid to a citric acid solution (previously prepared), under stirring and softly heating. After the molybdenum chelates is formed, 44.6 g of ammonium niobium oxalate is added. A homogeneous straw colored solution is immediately obtained. At that time, the pH of the solution is corrected to a value of 3, approximately, by adding concentrated ammonium hydroxide. After correcting the pH, 900 mL of ethylene glycol is added. Then the temperature of the reaction medium is raised to approximately 100° C., maintaining in this level until the major part of the water be removed and resulting in an homogeneous solution of low viscosity. The condensation reaction takes place at the same time the water is removed in the next stage, with moderate heating between 130° C. and 175° C., producing a highly viscous resin. Later, this resin is submitted to thermal treatments at rising temperatures.

In the first stage, the temperature is kept at approximately 290° C., for approximately 8 hours, obtaining a solid polymer resin. The total elimination of volatiles is carried out in a furnace, under a static atmosphere, at a temperature of approximately 400° C., after a period of between 8 and 12 hours. A bi-metal oxide is obtained ate 720° C., after maintaining it at this temperature for a period of between 5 and 10 hours, under a controlled oxygen atmosphere. This solid shall be referred to as MoNb-PC.

### EXAMPLE 7

In this example, the process to prepare mixed carbides from the corresponding bimetal oxides is described. These precursors are obtained through the co-precipitation/sol-gel (SG), solid-state reaction (SS), and Pechini (PC) methods, by thermal treatments in the presence of methane and hydrogen.

The carbides were synthesized using the temperature-programmed carburization (TPC) method. The carburization consists of depositing a suitable mass of mixed oxides, which may be molded by extrusion, or pressed into wafers or in powder form, in a quartz reactor, which is linked to an experimental unit by two CAJON® type connections.

During carburization, a mixture containing 20% (v/v) of CH₄ in H₂ has its flow rate adjusted to the desired value (approximately 350 mL/min.) and the reactor temperature is linearly raised at a constant rate from room temperature until reaching the final desired temperature (for example, 780° C.), remaining at this temperature for 90 minutes. At the end of the isothermal period, at the final temperature of synthesis, the gaseous mixture in the reactor, or, in other words, 20% (v/v) CH₄/H₂ is exchanged for pure He (50 mL/min.) and the reactor temperature is reduced to room temperature. The optimal temperature of carburization varies in function of the synthesis method and in function of the metals present in the multi-metal precursor.

In general terms, it is obvious that the synthesis method by “sol-gel” requires carburization temperatures around 50° C. lower than the temperatures required by the rest of the preparation methods.

The products obtained were tested in chemical reaction followed in the same synthesis reactor, avoiding contact with the atmosphere. When this was not possible, the carbide was passivated at room temperature, using, for this purpose, a mixture of 0.5% (v/y) of oxygen in He (conventional passivation procedure) and stored in a dry chamber.

Alternately, the newly prepared carbide was transferred to a dry chamber and collected in a flask containing an organic solvent, typically isooctane. The carburized solids, thus obtained, were called respectively, MoNb-SG/C, MoNb-SS/C and MoNb-PC/C.

A fourth sample was prepared from the MoNb-SG precursor, as previously referred, in the presence of NH₃, to obtain the corresponding mixed nitride. The nitrided solid was called MoNb-SG/N.

Regarding the development of mechanical strength during the carburization stage, the results indicate a reduction in the value of this property, ranging from 21 N/mm to 10 N/mm, in one experiment, and from 16 N/mm to 10 N/mm in a second experiment.

In Table 1 that follows, the specific areas of the solids obtained by the process of this invention are showed, and they are compared with values described in specialized literature, particularly by Oyama for mixed MoNb carbide, a material that is obtained through the “solid-state reaction”.

TABLE 1
Specific Area of Mixed Carbides and Nitrides.

| Sample | Method | Specific Area (m²/g) |
|---|---|---|
| Carbide: | Precursor obtained by co- | 186 |
| MoNb-SG/C | precipitation/sol-gel | |
| Carbide: | Precursor obtained by | 115 |
| MoNb-SS/C | “solid-state reaction″ | |
| Carbide: | Precursor obtained by | 150 |
| MoNb-PC/C | Pechini | |
| Carbide: | Precursor obtained by | 98 |
| MoNb/C | “solid-state reaction″ by | |
| | Oyama et al | |
| Nitride: | Precursor obtained by co- | 191 |
| MoNb-SG/N | precipitation/sol-gel | |

Initially, it is showed that the specific area values of the products obtained by solid-state synthesis (SS) by Oyama and in this work (Example 5) were very close, attesting the reproducibility of the process.

The values of the specific area of the mixed carbide obtained by the sol-gel method are clearly higher than the rest of the methods described in specialized literature, and particularly higher than those described by Oyama, with the advantage of being the carbide in an extruded form. The mixed oxide sample obtained by nitration prepared by the sol-gel method also shows an elevated specific area, similar to the corresponding carbide, indicating that the development of this property in carburized and nitrated materials are intimately related to the synthesis of mixed precursor oxide.

The extruded form of these materials in oxidized form, as described in Examples 1 to 6, as well as the carburized materials, as in Example 7, was submitted to crushing tests to determine their mechanical strength. This test determines the necessary force to crush the particles along their diameter, which means that the greater this value is, the greater is the strength of the material to mechanical forces, such as those applied by the weight of the catalyst itself, by the liquid retained in the spaces between the particles (“hold-up”) and by the loss of load caused by leakage.

A catalyst of low mechanical strength tends to disintegrate during their use, generating sharps and increasing the resistance to leaks inside the reactor.

As mentioned in the different Examples, materials were obtained having a mechanical strength suitable for industrial use. As a comparison, the technical literature indicates that an industrial catalyst made of mixed sulfides, such as NiMo supported in alumina, has a mechanical strength on the order of 8 N/mm, which has a lower value than found in the various materials prepared by this invention's process.

### EXAMPLE 8

A hydrocarbon stream in the gas-oil range (diesel), from Cabiunas oil and containing 4200 ppm of S and 1360 ppm of N by weight, was submitted to the conversion process using the catalysts above described, for the purpose of removing sulfide and nitrogenated compounds. This gas-oil stream was placed in contact with the catalysts in the carburized form, at hydrogen pressure of 80 bar, temperature in the range of 340 to 380° C., with a H₂/load ratio of 600 NL/L, and a spatial velocity of 2 h⁻¹. The catalyst, immersed in iso-octane, was transferred in an inert atmosphere to the reactor, remaining immersed in the solvent in order to protect it from oxidation of the air. The load containing the catalyst was fed into the laboratory's trickle bed reactor and was stabilized for at least 30 hours at 320° C. under referred load reaction conditions.

After this period, the temperature was raised to the desired reaction temperature and stabilization was carried out once more, accompanied by the constancy of properties of the obtained products. At the reactor exit, a gas-liquid separator allowed the separation of the liquid product resulting from this treatment. In Table 2, the conversions of sulfurated compounds (HDS) and nitrogenated compounds (HDN) are compared at different temperatures, for carbides prepared in accordance with the descriptions found in Examples 1 to 7 above.

TABLE 2
Gas-Oil Hydrotreatment

Reaction Temperature (° C.)

| | | 340 | 360 | 380 |
|---|---|---|---|---|
| MoNb-SG/C | HDS (%) | 20.4 | 47.4 | 61.4 |
| | HDN (%) | 13.2 | 25.0 | 33.8 |
| MoNb-PC/C | HDS (%) | 4.0 | 23.2 | 41.9 |
| | HDN (%) | 0.7 | 16.2 | 25.0 |
| MoNb-SS/C | HDS (%) | 1.9 | 26.2 | 31.0 |
| | HDN (%) | 1.5 | 8.4 | 10.7 |

* Removal of sulfurated compounds (HDS) and Removal of nitrogenated compounds (HDN).

It is clearly shown that the mixed carbide obtained by the process presented by this invention offers superior performance to carbides obtained by the solid-state synthesis method, described by Oyama and by the Pechini synthesis method.

The best results were obtained by solids with the greatest specific area as shown in Table 1, indicating a direct correlation between catalytic activity and the specific area of these mass catalysts.

### EXAMPLE 9

A hydrocarbon stream in the gas-oil (diesel) range was pre-hydrotreated with conventional catalysts made of mixed Ni and Mo sulfides in order to reduce sulfur and nitrogen levels in this stream. The product obtained from this process, containing 45 ppm of S and 146 ppm of N respectively, was then placed in contact with the MoNb-SG/C catalysts in a reactor on a trickle bed in the presence of 80 bar of hydrogen and temperature from 320 to 360° C., with a H₂/load ratio of 600 NL/L, and with a spatial velocity of 2 h⁻¹. The objective of this test was to evaluate the potential of this catalyst in two stage hydrotreatment aiming the production of fuels with extremely low sulfur levels.

The results are shown in Table 3, where it is compared with the performance of an HDT industrial catalyst made of Ni and Mo sulfides.

TABLE 3
Hydrogenated Gas-Oil Hydrotreatment

| | | Reaction Temperature (° C.) | | |
|---|---|---|---|---|
| Catalyst | | 320 | 340 | 360 |
| MoNb-SG/C | HDS (%) | 55.0 | 78.9 | 70.0 |
| | HDN (%) | 61.9 | 95.7 | 94.0 |
| NiMoS | HDS (%) | 32.2 | — | 52.2 |
| | HDN (%) | 25.5 | 26.8 | 32.3 |

* Removal of sulfurated compounds (HDS) and Removal of nitrogenated compounds (HDN).

The results in Table 3 show that the catalyst obtained by this invention is more suitable to the hydrotreatment of hydrogenated gas-oils in order to obtain an ultra-clean fuel, than commercial catalysts made from transition metal sulfides.

The carbide catalyst has, for this load, an optimal operational temperature of around 340° C.

### EXAMPLE 10

The sensitivity of transition metal carbides to oxygen is well known in the literature, and some materials have a pyrophoric characteristic. Passivation with oxygen at low concentrations at room temperature has been reported by some researchers as being effective in retaining the physicochemical and catalytic properties of these materials.

The process of passivation consists of exposing the newly prepared catalyst to a flow containing low concentrations of oxygen (usually<1%, preferably<0.5%) at room temperature, during sufficient time to promote superficial oxidation of the catalyst, and without altering the composition and structure of the sub-surface layers. The catalytic properties would be restored through catalyst reduction, in-situ, with pure hydrogen at temperatures from 300 to 500° C.

However, there is some disagreement in the literature regarding the efficacy of this process, since other researchers have observed a definite loss of catalytic activity using this procedure. For this reason, in several works, the catalyst is evaluated/characterized immediately after the synthesis and in the same reactor used for this purpose.

On the other hand, industrial use of this type of catalyst implies that, for security reasons and synthesis conditions, the catalyst be prepared ex-situ and transferred to the industrial reactor.

This passivation procedure was used initially with the carbide samples prepared as explained in Examples 1 to 7, which have a null or very low catalytic activity, when compared with the results presented in Examples 8 and 9. In order to bypass this inconvenience, the newly prepared carbides were collected in an organic solvent, such as n-hexane, iso-octane or heavier, and stored in a dry chamber for months.

To transfer this to the test reactor, it took care to keep the catalyst continuously immersed in the organic solvent in order to avoid contact with oxygen. This procedure allows to remain intact the catalytic properties of these solids, whose catalytic activities were presented in Examples 8 and 9.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the scope of the appended claims.

1. Process to prepare molded mixed carbides and nitrides characterized by including the following stages:
a) mix, by stirring, at least two solutions prepared by dissolving soluble compound of metals, in which at least one is a transition metal, under controlled conditions of temperature, pH, metal concentration, and time of addition, set in function of the metals involved, until a formation occurs, and in some cases occurs the age of a precipitate;
b) adjust, in some cases, the pH of the reaction medium for the action of an inorganic acid or basic, added to the reaction medium in order to accelerate the co-precipitation stage;
c) filter and/or centrifuge the precipitate in order to obtain a moist paste that provides conditions for molding;
d) peptize and re-disperse the solid in an acid or basic agent so as to obtain a suspension with binding properties;
e) eliminate the excess of moisture from the solid obtained and form it in accordance with the selected technique, preferably by extrusion;
f) dry and calcine the formatted solid, according to the selected temperature programming, set in function of the metals present in the precursor, in order to obtain a mixed metal oxide to ready to be carburized, nitrided, or sulfonated;
g) expose the mixed metal oxide to a treatment stream that takes it to form a molded mixed carbide, a molded mixed nitride, or a molded mixed sulfide; and
h) store molded carbides and nitrites in an organic compound that is liquid or solid at room temperature.

2. Process to prepare molded mixed carbides and nitrides in accordance with claim 1, wherein the metal is selected from among molybdenum, tungsten, niobium, and nickel.

3. Process to prepare molded mixed carbides and nitrites nitrides in accordance with claim 1, wherein the precursors of the metal oxides are metallic salts selected from among nitrites, chlorides, carbonates, phosphates, sulfates, or oxalates of selected metals.

4. Process to prepare molded mixed carbides and nitrides in accordance with claim 1, wherein the precursors of metal oxide where the metal is in the form of an anionic complex, are selected from molybdates, niobates or chromates.

5. Process to prepare molded mixed carbides and nitrides in accordance with claim 1, wherein at least one of the metal oxide precursors possesses a functional group that may be decomposed or volatilized after the stage of mixing the solutions, in such a way that the pH of the solution changes and favors co-precipitation of the salts.

6. Process to prepare molded mixed carbides and nitrides in accordance with claim 5, wherein the metal oxide precursors are selected from compounds that generate ammonia, urea or another volatile agent.

7. Process to prepare molded mixed carbides and nitrites nitrides in accordance with claim 1, wherein hydrogen, carbon monoxide or a mixture of both are used as a reducing agent.

8. Process to prepare molded mixed carbides and nitrides in accordance with claim 1, wherein the carburization stage uses as a carbon source: hydrocarbons, such as alkanes, preferably methane, cycloalkanes, and oil streams.

9. Process to prepare molded mixed carbides and nitrides in accordance with claim 1, wherein the nitrided uses ammonia as a nitrogen source.

10. Process to prepare molded mixed carbides and nitrides in accordance with claim 1, wherein the catalyst newly prepared is collected in a liquid organic compound selected from paraffins, isoparaffins, cycloparaffins, aromatics, polyaromatics, or combinations of these functions.

11. Molded mixed carbide and nitride catalyst prepared through co-precipitation of mixed metal oxides, for the purpose of obtaining a paste with binding properties, that provide proper conditions for formatting, especially by extrusion, particularly suitable for preparing mixed carbides and nitrides in extruded form, provided with high superficial area and high mechanical strength.

12. Molded mixed carbide and nitride catalyst in accordance with claim 11, prepared from at least two precursor solutions of metallic salts, in which at least one of these is a transition metal, under controlled conditions of temperature, ph, metal concentration, and addition time, all in function of the metallic salt selected.

13. Molded mixed carbide and nitride catalyst in accordance with claim 11, wherein the metal is selected from among molybdenum, tungsten, niobium, and nickel.

14. Molded mixed carbide and nitride catalyst in accordance with claim 11, wherein the precursors of the metal oxides are selected from among nitrates, chlorides, carbonates, phosphates and sulfates of the selected metals.

15. Molded mixed carbide and nitride catalyst in accordance with claim 11, wherein the precursors of metal oxide precursors where the metal is in the form of an anionic complex, are selected from molybdates, niobates or chromates.

16. Molded mixed carbide and nitride catalyst in accordance with claim 11, wherein at least one of the metal oxide precursor possess a functional group that may be decomposed or volatilized after the stage of mixing the solutions, in such a way that the pH of the solution changes and favors co-precipitation of the salts.

17. Molded mixed carbide and nitride catalyst in accordance with claim 16, wherein metal oxide precursors are selected from compounds that generate ammonia, urea or another volatile agent.

18. Molded mixed carbide and nitride catalyst in accordance with claim 11, wherein a calcination stage is performed according to a programmed temperature in the range of 100° C. to 1000° C., preferably between 200° C. and 700° C.

19. Molded mixed carbide and nitride catalyst in accordance with claim 11, characterized by being collected in a liquid organic compound selected from paraffins, isoparaffins, cycloparaffins, aromatics, polyaromatics, or combinations of these functions, immediately after its preparation.

20. Molded mixed carbide and nitride catalyst in accordance with claim 11, characterized by being used in hydro processing reactions, such as for the removal of organo-sulphurized compounds, removal of organo-nitrogenized compounds, removal of unsaturated and aromatic compounds, and conversion of heavy compounds in lighter fractions, specially applied to hydrocarbon streams in the range of naphtha, kerosene, gas-oils, heavy and waste gas-oils.

21. Hydrotreatment process for a hydrocarbon stream wherein the hydrocarbon stream is contacted with a mixed and molded carbide and/or nitride catalyst, prepared in accordance to the process of claim 1, in the presence of hydrogen, at a temperature in the range of 200° C. to 450° C., pressure in the range of 20 to 150 kgf/cm², ratio of H₂/hydrocarbon load, between 100 and 1000 NL/L and spatial velocity between 0.3 and 5 h⁻¹ for the purpose of removing sulfurated, nitrated, and aromatic compounds which are load contaminants.

22. Hydrotreatment process of a hydrocarbon stream characterized by using a hydrocarbon stream that has been pre-hydrotreated, in order to reduce the total level of sulfurated compounds, and contacts the referred hydrocarbon stream which were previously hydrotreated with a mixed and molded carbide and/or nitride catalyst, prepared in accordance with the process of claim 1, in the presence of hydrogen, at a temperature in the range of 200° C. to 450° C., pressure from 20 to 150 kgf/cm², ratio of H₂/hydrocarbon load, around to 600 NL/L and spatial velocity on the order of 2 h⁻¹ for the purpose of removing sulfurated, nitrated, and aromatic compounds which are load contaminants.
